(19) United States
(12) Patent Application Publication
(10) Pub. No.: US 2006/0205521 A1
(43) Pub. Date: Sep. 14, 2006

(54) Tripod constant velocity joint structure

(75) Inventor: Dong-Young Yoon, Cheongju-si (KR)

Correspondence Address: DICKSTEIN SHAPIRO LLP, 1825 EYE STREET NW, Washington, DC, 20006-5403, US

(73) Assignee: Korea Flange Co., Ltd.

(21) Appl. No.: 11/114,131

(22) Filed: Apr. 26, 2005

(30) Foreign Application Priority Data
Mar. 10, 2005 (KR) 10-2005-0020133

(51) Int. Cl. F16D 3/26

(52) U.S. Cl. 464/111

(57) ABSTRACT

The tripod constant velocity joint is stably retained in structure thereof and the frictional force between a trunnion and track is minimized, thus obtaining a stable operation and durability of the constant velocity joint. The tripod constant velocity joint includes an inner roller, outer roller, roller groove, and a plurality of recesses.

### CROSS-REFERENCE TO RELATED APPLICATIONS

The present application is based on, and claims priority from, Korean Application Serial Number 10-2005-0020133, filed on Mar. 10, 2005, the disclosure of which is hereby incorporated by reference herein in its entirety.

### FIELD OF THE INVENTION

The present invention relates to a tripod constant velocity joint structure. More particularly, the present invention relates to a structure of an outer roller and trunnion of a spider.

### BACKGROUND OF THE INVENTION

A tripod constant velocity (CV) joint transmits the torque by using a housing and spider, wherein the housing is integrally connected to a stub shaft, and the spider in the housing is splined to a half shaft. Three trunnions of the spider are mounted with a roller and bearing, respectively, for absorption of the relative motion that generates between the trunnions and tracks of the housing.

If the stub shaft and half shaft of the tripod CV joint are bent, relative motion occurs between the trunnion, roller, bearing and track. The frictional resistance from the above relative motion generates an axial force in the axial direction of the half shaft. The axial force has three peak values per one revolution of the tripod constant joint.

A large axial force is produced when a great load is applied onto the CV joint (e.g. a sudden vehicle start) or when the joint angle is large, causing lateral vibrations of the vehicle.

### SUMMARY OF THE INVENTION

Embodiments of the present invention are provided to retain the structural stabilization of a tripod constant joint (CV) and to minimize the frictional force between a trunnion and track, thereby greatly decreasing the occurrence of the axial force, and acquiring a stable operation and durability of the CV joint.

A tripod CV joint includes an inner roller and outer roller disposed between a track of a housing and a trunnion of a spider. A roller groove is formed at the middle of the periphery of the outer roller along the circumferential direction of the outer roller. A plurality of recesses is formed on the surface of the trunnion for reducing the contact area with the inner roller.

### BRIEF DESCRIPTION OF THE DRAWINGS

For a better understanding of the nature and objects of the present invention, reference should be made to the following detailed description with the accompanying drawings, in which:

FIG. 1 illustrates a tripod CV joint construction according to an embodiment of the present invention;

FIG. 2 is a cross-sectional view illustrating the coupled state of a housing and spider of FIG. 1;

FIG. 3 is an enlarged partial view of FIG. 2;

FIG. 4 is a cross-sectional view taken along line IV-IV of FIG. 2;

FIG. 5 illustrates the construction of a trunnion;

FIG. 6 is a cross-sectional view taken along line VI-VI of FIG. 5;

FIG. 7 is a cross-sectional view taken along line VII-VII of FIG. 5;

FIG. 8 is a cross-sectional view taken along line VIII-VIII of FIG. 5; and

FIG. 9 is a three-dimensional view of the spider of FIG. 1.

### DETAILED DESCRIPTION OF THE PREFERRED EMBODIMENTS

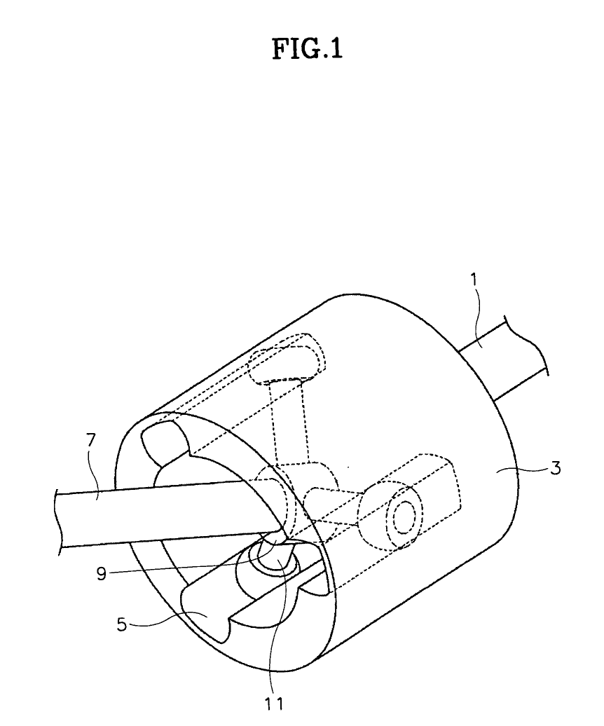

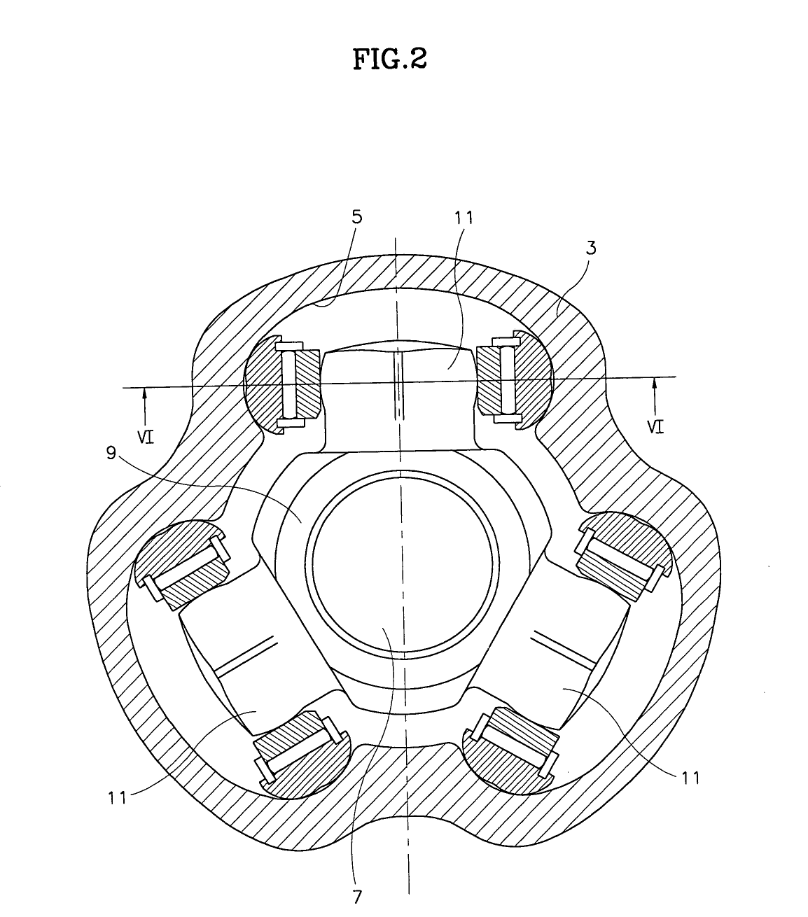

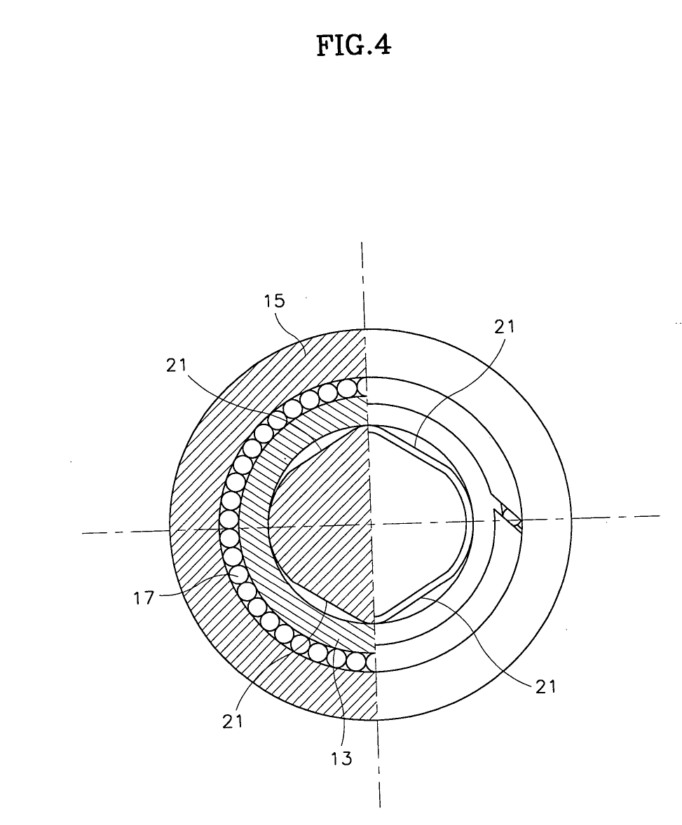

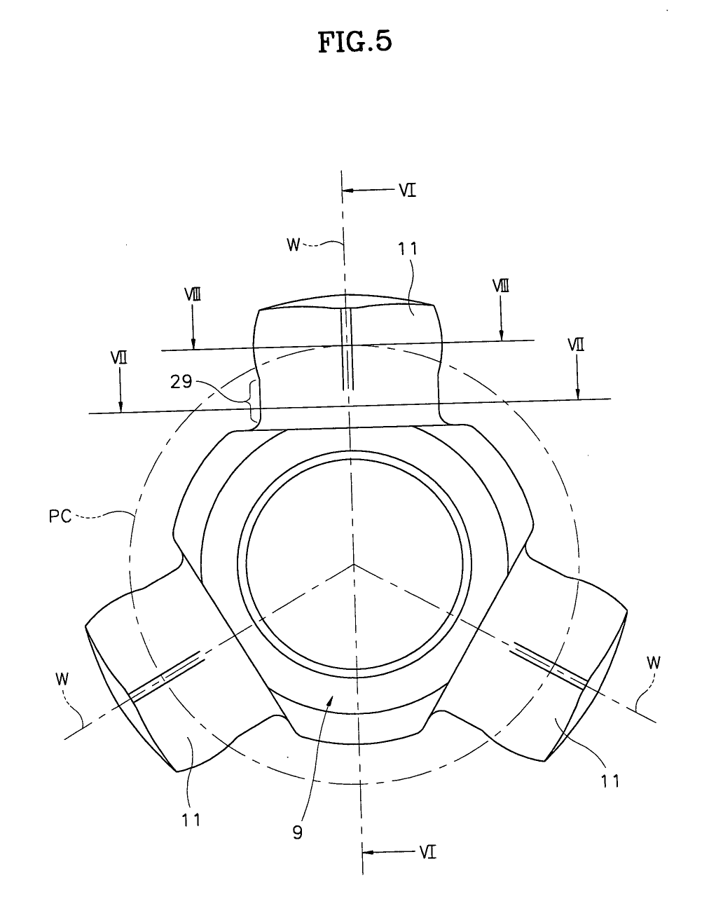

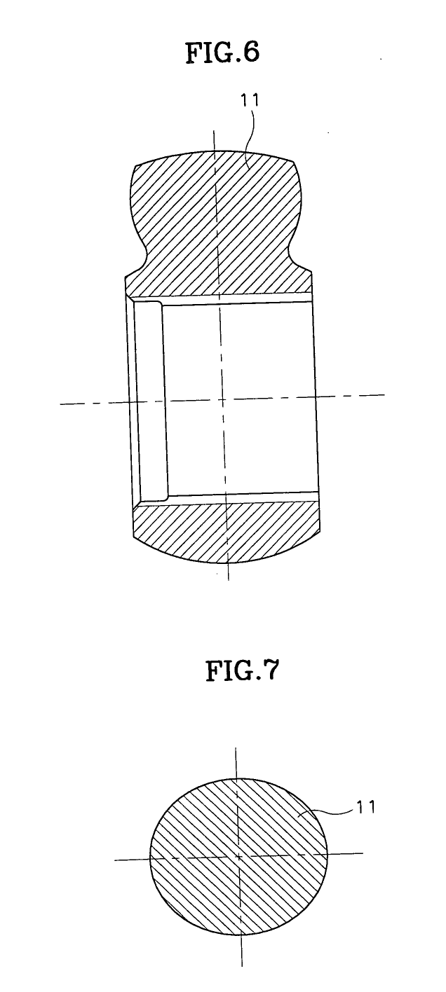

Referring to FIGS. 1 through 9, a tripod constant velocity (CV) joint according to an embodiment of the present invention includes an inner roller 13 and outer roller 15 that are disposed between a track 5 of a housing 3, which is connected to a stub shaft 1, and a trunnion 11 of a spider 9 connected to a half shaft 7. A needle bearing 17 is situated between inner roller 13 and outer roller 15. A roller groove 19 is formed at the middle of the periphery of outer roller 15 along the circumferential direction of outer roller 15. A plurality of recesses 21 is formed on the surface of trunnion 11 to reduce the contact area to inner roller 13.

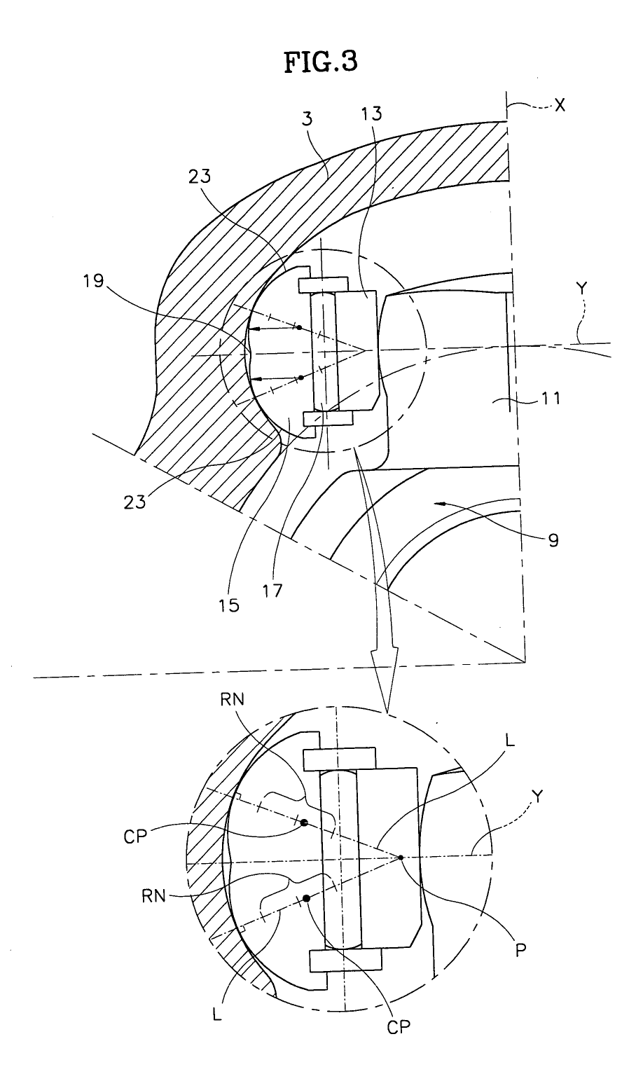

Roller groove 19 of outer roller 15 is formed at the joint of two arcs 23 (see FIG. 3). Two arcs 23 are formed at both sides of a dividing line (Y) that is on a cross-section parallel to a rotational center axis (X) of outer roller 15 and bisects outer roller 15. Radius centers (CP) of arcs 23 are in the range (RN) of ¼-¾ of each line segment (L) from a contact points on where arc 23 and track 5 are in contact with each other. The line segment (L) meets the dividing line (Y) and perpendicularly connects to arc 23 at the contact point.

As the radius centers of two arcs 23 are symmetrically placed in relation to the dividing line (Y), two arcs 23 are symmetrically formed in relation to the dividing line (Y).

The two line segments (L) connecting the dividing line (Y) with the contact points of arcs 23 and track 5 encounter each other on the dividing line (Y). This means track 5 of housing 3 is formed by a constant radius at the contact portion with outer roller 15, and the center point of the radius is an intersection (P) of the two line segments (L) and dividing line (Y).

Roller groove 19 is formed at the periphery of outer roller 15 by rotating two arcs 23 of FIG. 3 in relation to the rotational center axis (X) of outer roller 15.

Outer roller 15 can be supported at four points in track 5 of housing 3 with roller groove 19, thereby stably retaining the position. Further, the oil contained in roller groove 19 smoothly lubricates between outer roller 15 and track 5.

The contact area between outer roller 15 and track 5 of housing 3 is decreased and the oil in roller groove 19 improves the lubrication function, resulting in a reduction of the frictional force between track 5 and outer roller 15 as well as the axial force occurring when the tripod CV joint transmits the torque.

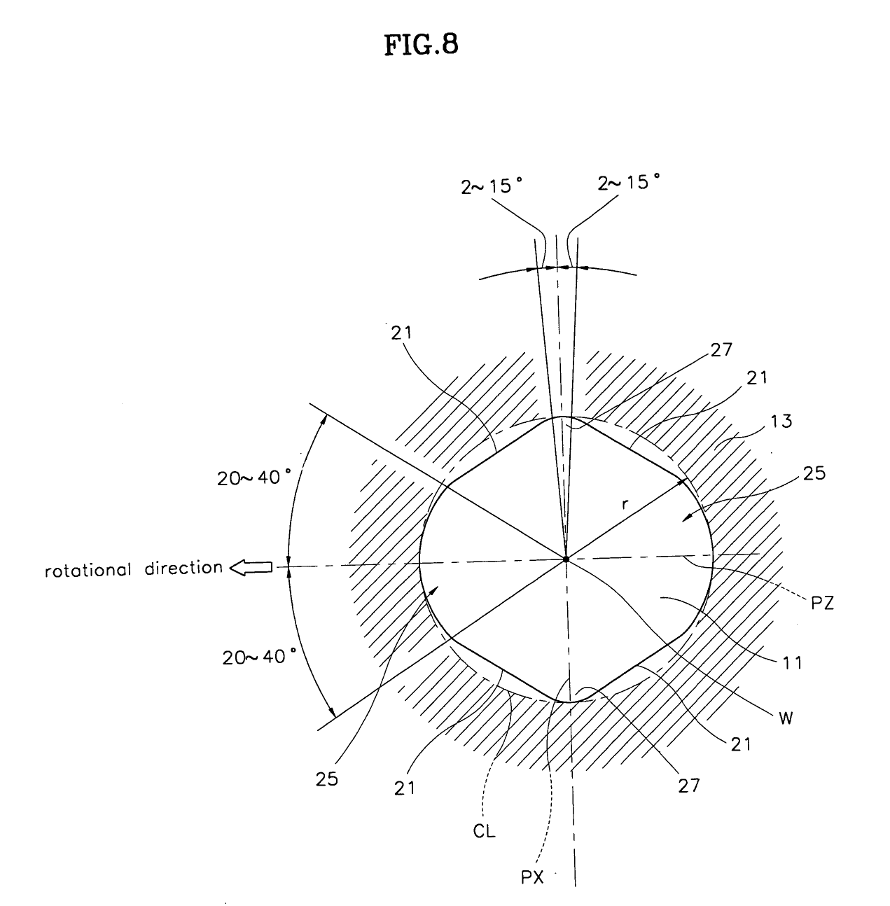

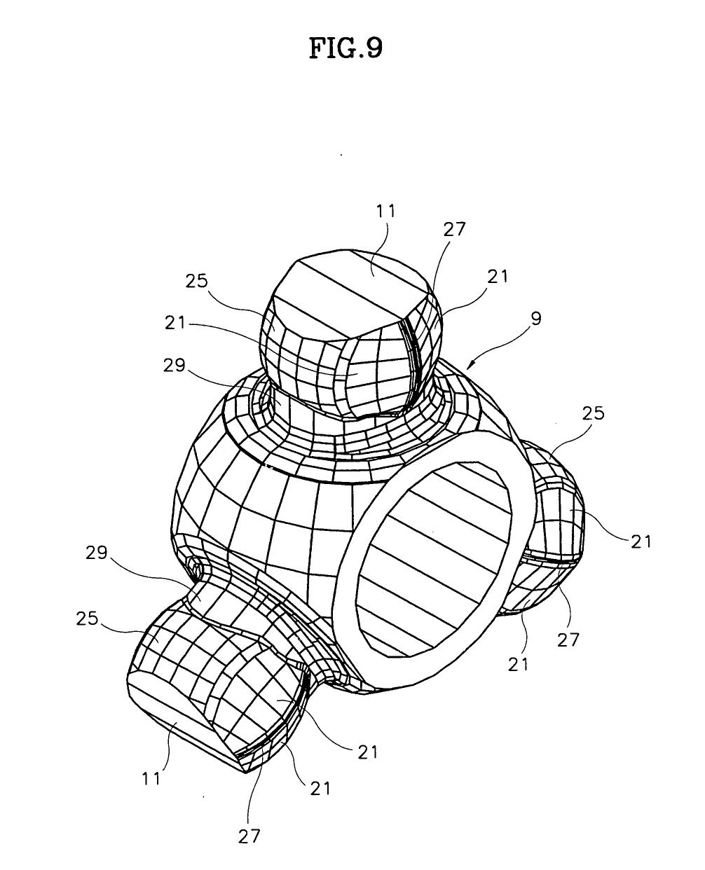

Referring now to FIGS. 8 and 9, recesses 21 of trunnion 11 are formed between wide angle parts 25 and narrow angle parts 27 on a lateral cross-section of trunnion 11 which contacts a pitch circle (PC) of trunnion 11. Wide angle parts 25 are formed along the rotational direction of trunnion 11 while narrow angle parts 27 are formed perpendicularly to the rotational direction of trunnion 11 and are reduced in width compared to wide angle parts 25.

Wide angle parts 25 and narrow angle parts 27 are formed by an identical rotational radius (r) from a center axis (W) of trunnion 11.

A circle (CL) is formed on the lateral cross-section to form the periphery of wide angle parts 25 and narrow angle parts 27 with the center axis (W) of trunnion 11 as the center thereof. Recesses 21 are formed by depressing the circle (CL) inwardly between wide angle parts 25 and narrow angle parts 27.

Wide angle parts 25 are preferably formed by a constant rotational radius in the range of approximately 20 to 40 degrees at both sides of a rotation plane (PZ) of trunnion 11. Narrow angle parts 27 are preferably formed by a constant rotational radius in the range of approximately 2 to 15 degrees at both sides of a plane (PX) that is perpendicular to the PZ of trunnion 11.

Recesses 21 are determined in formation thereof by wide angle parts 25 and narrow angle parts 27.

Trunnion 11 contacts inner roller 13 only at wide angle parts 25 and narrow angle parts 27. Recesses 21 form a space between inner roller 13 and recesses 21 so as to contain the oil for lubrication.

Thus, the contact area between trunnion 11 and inner roller 13 is remarkably reduced, and the lubrication between trunnion 11 and inner roller 13 is smoothly performed, thereby effectively reducing the frictional force between trunnion 11 and inner roller 13 during the power transmission of the tripod CV joint and preventing the axial force, accordingly.

Consequently, most of the load applied when the tripod CV joint transmits the power is supported by wide angle parts 25 of trunnion 11, and narrow angle parts 27 primarily and stably maintain the coupled state of inner roller 13 and trunion 11 regardless of recesses 21.

The contact area between inner roller 13 and trunnion 11 is reduced by using recesses 21 and the coupled state of inner roller 13 and trunnion 11 is stably retained by narrow angle parts 27.

In reference to FIG. 7, a neck portion 29 of trunnion 11 has an ellipse-shaped cross section formed with a long axis along the rotational direction of trunnion 11.

Under the transmission of the constant rotational force, if the cross-section of the neck portion is elliptical rather than circular, the weight of the neck portion can relatively be reduced.

The tripod CV joint thus constructed reduces the frictional force between outer roller 15 and track 5 and the frictional force between trunnion 11 and inner roller 13 via roller groove 19 and the plurality of recesses 21, thereby greatly reducing the axial force generated when the tripod CV joint transmits torque.

As apparent from the foregoing, there is an advantage in that the structural stabilization of the tripod CV joint is retained and the frictional force between the trunnion and track is minimized, thus remarkably decreasing the axial force and improving the stable operation and durability of the CV joint.

What is claimed is:

1. A structure of a tripod constant velocity joint comprises:
an inner roller and outer roller that are disposed between a track of a housing and a trunnion of a spider;
a roller groove formed at a middle of a periphery of said outer roller along a circumferential direction of said outer roller; and
a plurality of recesses formed on a surface of said trunnion for reducing a contact area with said inner roller.

2. The structure as defined in claim 1, wherein said roller groove of said outer roller is formed at a joint of two arcs, said two arcs being formed at both sides of a dividing line that is on a cross-section parallel to a rotational center axis of said outer roller and bisects said outer roller, and radius centers of said arcs are within a ¼-¾ range of each line segment from a contact point on where said arc and track are in contact with each other wherein the line segment meets the dividing line and perpendicularly connects to said arc at the contact point.

3. The structure as defined in claim 1, wherein said recesses of said trunnion are formed between wide angle parts and narrow angle parts on a lateral cross-section of said trunnion which contacts a pitch circle of said trunnion, wherein said wide angle parts are formed along a rotational direction of said trunnion while said narrow angle parts are formed perpendicularly to the rotational direction of said trunnion and are reduced in width compared to said wide angle parts, wherein said wide angle parts and narrow angle parts are formed by an identical rotational radius from a center axis of said trunnion.

4. The structure as defined in claim 3, wherein said wide angle parts are formed by a constant rotational radius in a range of 20 to 40 degrees at both sides of a rotation plane of said trunnion, and said narrow angle parts are formed by a constant rotational radius in a range of 2 to 15 degrees at both sides of a plane that is perpendicular to the rotation plane of said trunnion.

5. The structure as defined in claim 1, wherein a neck portion of said trunnion has an ellipse-shaped cross section formed with a long axis along a rotational direction of said trunnion.
